(19) United States
(12) Patent Application Publication
(10) Pub. No.: US 2009/0319758 A1
(43) Pub. Date: Dec. 24, 2009

(54) Processor, performance profiling apparatus, performance profiling method , and computer product

(75) Inventor: Shigeru KIMURA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU MICROELECTRONICS LIMITED, Tokyo (JP)

(21) Appl. No.: 12/379,549

(22) Filed: Feb. 24, 2009

(30) Foreign Application Priority Data
Jun. 19, 2008 (JP) 2008-160429

(51) Int. Cl. G06F 9/46; G06F 9/00

(52) U.S. Cl. 712/220; 719/318; 712/E09.001

(57) ABSTRACT

A processor capable of executing an arbitrary application program on an operating system includes an event context register that stores therein an ID of an event to be measured in the arbitrary application program and a context register that records therein an ID of an event executed by the arbitrary application program upon the application program being executed on the operating system. The processor further includes a comparator that compares the ID of the event recorded in the context register and the ID of the event to be measured that is stored in the event context register and an event counter that counts the number of times the ID of the event recorded in the context register and the ID of the event to be measured are determined to coincide by the comparator.

### CROSS REFERENCE TO RELATED APPLICATIONS

This application is based upon and claims the benefit of priority of the prior Japanese Patent Application No. 2008-160429, filed on Jun. 19, 2008, the entire contents of which are incorporated herein by reference.

### FIELD

The embodiment discussed herein is related to performance profiling of a program under execution.

### BACKGROUND

Conventionally, many processors are provided with counters for counting events within a processor (hereinafter, “event counter”), events occurring during communication with external apparatuses, etc. For example, Intel's Pentium (registered trademark) processor has counters configured to function as event counters that selectively count events from among a large number of events including the number of clocks, the number of execution instructions, the number of cache errors, etc. Such counting function enables analysis of the operation of the processor, like analysis to determine which process of an application program (hereinafter, “program”) executed by the processor is used frequently.

In addition to the processor above, IBM's PowerPC processor also adopts a configuration having plural counters similar to the Pentium processor and is capable of selectively counting events from among a large number of events, enabling architecture event information such as pipeline stall, memory traffic, bus load information, and program counter (PC) information to be acquired simultaneously. By referencing such information, analysis is possible to determine at which function or process events occur frequently. By continuously acquiring such information in chronological order and visually outputting it by means of a graph, etc., local problematic areas, transition of the event information throughout the entire system, and high-load areas can be identified (see, for example, Japanese Laid-Open Patent Application Publication No. 2004-318538).

Conventionally, to acquire such event information, two techniques are used, a cumulative type and an interrupt type. For the cumulative type, each time a specified event (e.g., the number of execution cycles and the number of cache errors) occurs, the event value is incremented. By the processor storing a cumulative value of the event value indicative of the number of times the event occurred within a monitoring range as counted by the event counter, the event information is acquired.

For the interrupt type, the processor includes, in addition to the event counter, a counter mechanism that generates an interrupt whenever the number of times that an event (specified event such as the number of execution cycles and the number of cache errors) occurs exceeds a given threshold. An interrupt handler (a program to be called depending on the contents of the interrupt) acquires event information, such as the address of the instruction when an interrupt is generated (program counter) and the count value of the event counter, and is capable of identifying the function or the instruction at which the event has occurred.

Events provide information indicative of operation of hardware in the processor, for example:
number of execution cycles
number of cache errors
number of translation lookaside buffer (TLB) errors
number of execution instructions
degree of execution instruction parallelism
number of branch instructions executed
number of specified instructions executed
pipeline stall factor
number of register interference cycles
bus access information

Adoption of any one of the techniques above generally depends on the hardware configuration of the processor executing the program. Even for a processor that does not have an interrupt generating function, acquisition of the interrupt-type event information described above can be realized by using a function of interrupting at given intervals by an internal interval timer of the processor.

However, to acquire the event information, i.e., performance profiling of the program, using the above conventional technologies, a dedicated program must be prepared by adding event information processing to an ordinary program. FIG. 13 is a diagram of conventional performance profiling. As depicted in FIG. 13, a processor 1300 includes a program executing unit 1301, an event counter 1302, and a program counter 1303.

An example will now be described in which the processor 1300 causes the program executing unit 1301 to execute a program 1304 that is to be subject to performance profiling and performs the performance profiling on the program 1304. As depicted in FIG. 13, the program 1304 includes, before and after a function or a routine on which the performance profiling is desired to be performed, a performance profiling start call command 1310, a performance profiling end call command 1320, and a performance profiling function (acquisition routine).

The program 1304 being executed must be modified for the performance profiling to a configuration different from the original configuration. Although debugging information and a source program described in C language, etc., (since the programming language is irrelevant, hereinafter “source program”) are required at the time of counting events, the event information of a program without such an environment cannot be acquired. Since the event acquisition routine is linked to the program, an error of the acquired event is caused. For example, when instruction cache information is specified as the event, since the event acquisition routine is linked to the program, various problems are involved such as a large code size and side effects caused by the event acquisition routine.

In the operating system (OS) environment, a utilization state frequently occurs in which in which the program for which the performance profiling is desired and another program are executed simultaneously. FIG. 14 is a diagram of count processing by the event counter when multiple programs are executed. Even if a process 1 and a process 2 are simultaneously executed as depicted in FIG. 14, events occurring with the process 1 and events occurring with the process 2 are counted by the same event counter 1302. Therefore, the event information and the program counter information of the target program alone cannot be acquired.

### SUMMARY

According to an aspect of an embodiment, a processor capable of executing an arbitrary application program on an operating system includes an event context register that stores therein an ID of an event to be measured in the arbitrary application program; a context register that records therein an ID of an event executed by the arbitrary application program upon the application program being executed on the operating system; a comparator that compares the ID of the event recorded in the context register and the ID of the event to be measured that is stored in the event context register; and an event counter that counts the number of times the ID of the event recorded in the context register and the ID of the event to be measured are determined to coincide by the comparator.

### BRIEF DESCRIPTION OF DRAWINGS

FIG. 1 is a diagram outlining performance profiling according to an embodiment;

FIG. 2 is a diagram of a configuration of a performance profiling acquisition tool;

FIG. 3 is a block diagram of a configuration of a processor;

FIG. 4 depicts a flowchart of processing performed by an event acquiring driver;

FIG. 5 is a flowchart of processing performed by the performance profiling acquisition tool;

FIGS. 6 and 7 are flowcharts of a procedure of a kernel at the time of acquisition of event information;

FIG. 8 is a flowchart of a tuning procedure based on the event information;

FIGS. 9 and 10 are schematics of an input example of the performance profiling acquisition tool;

FIGS. 11 and 12 are schematics of an output example of the performance profiling acquisition tool;

FIG. 13 is a diagram of conventional performance profiling; and

FIG. 14 is a diagram of count processing by an event counter when multiple programs are executed.

### DESCRIPTION OF EMBODIMENT(S)

Preferred embodiments will be explained with reference to the accompanying drawings. According to an embodiment, a register storing therein an ID of an event to be measured is prepared, the ID of an event executed and the registered ID are compared, and only when the IDs coincide, an event counter is incremented. Thus, the event counter can acquire event information specific to the event to be measured. It is unnecessary to embed an event information acquiring command in the program to be measured itself. In the following description, processing for acquiring the performance profiling by specifying a process is given as one example of an event included in an application program.

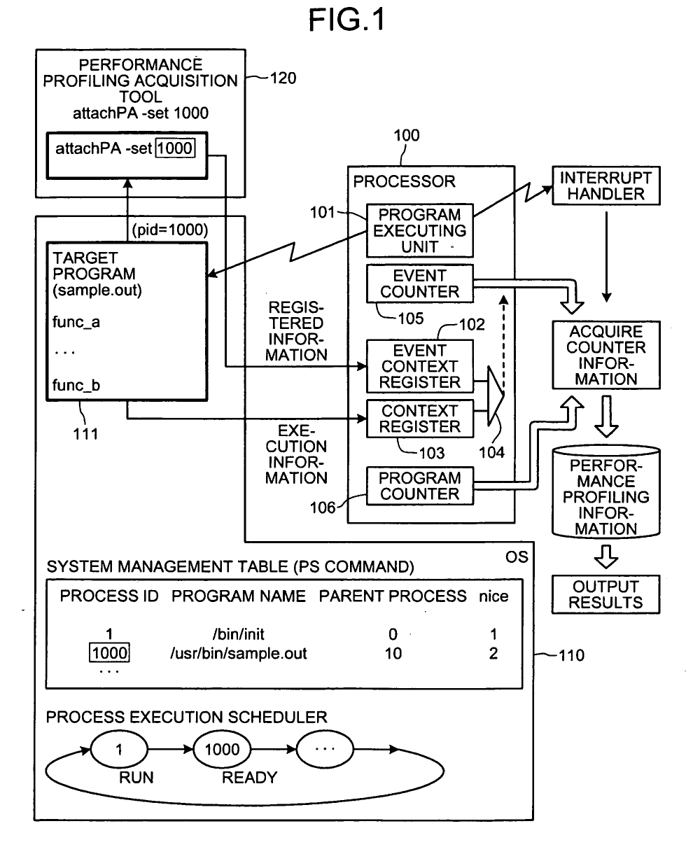

FIG. 1 is a diagram outlining performance profiling according to the present embodiment. In the present embodiment, a processor 100 newly includes an event context register in addition to a conventional event counter, an event mode setting register, a threshold storing register, a context register, etc. On an OS 110, a target program 111 to be subject to processing is executed by a program executing unit 101 of the processor 100 configured as described.

When performance profiling is to be performed, a performance profiling acquisition tool 120 is executed. The performance profiling acquisition tool 120 causes computer hardware resources to function as a registering unit that registers, in an event context register 102, a process ID of a target process; an acquiring unit that acquires event information, such as an event count for the target process as counted by an event counter 105; and an output unit that outputs the information acquired by the acquiring unit.

For example, the event context register 102 registers the process ID of the target process within the target program 111. When the target program 111 is executed under the environment of the OS 110, the performance profiling acquisition tool 120 causes a context register 103 of the processor 100 to record, as execution information, the process ID of the target program 111 being executed. The process ID recorded in the context register 103 is compared by a comparator 104 with the process ID of the target process that is registered in the event context register 102. The comparator 104 outputs a counting instruction to the event counter 105 only if the process IDs compared are identical. Thus, count results of the event counter 105 are output as event information specific to the target process identified by the process ID. Like the conventional processor, the processor 100 includes a program counter 106 and is capable of outputting program count results coinciding with the timing of counting of the event counter 105. Therefore, the count results of the event correlated with the program count of the program counter 106 are acquired from the processor 100 as performance profiling information.

While, in the description above, the event context register 102 registers a process in the program to be executed on the OS 110 as a target, the target is not limited to a process. Similarly, a task, a thread, etc. may be registered as the target. Therefore, while the following description takes a process as the target for the sake of convenience, the processing may be with respect to a task, a thread, etc.

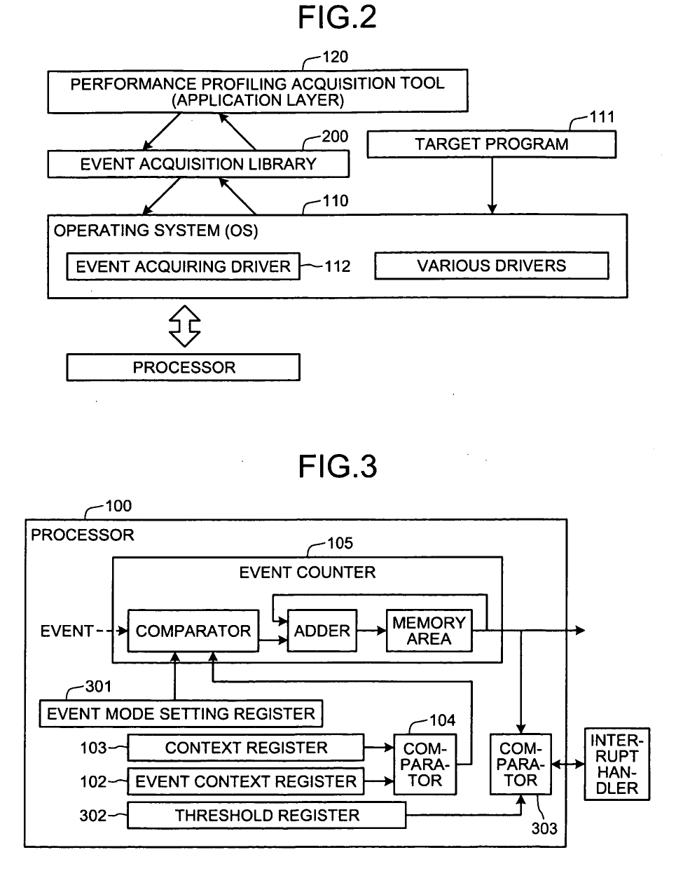

FIG. 2 is a diagram of a configuration of the performance profiling acquisition tool. In the present embodiment, by applying the performance profiling acquisition tool 120 to the computer that causes the processor 100 to execute the target program 111, such a performance profiling apparatus as described above is realized. The performance profiling acquisition tool 120 acquires event information of the target program 111 by specifying, with respect to the target program 111 and by means of parameters, the process ID, the event to be acquired, acquisition authorization, and an interrupt threshold.

As depicted in FIG. 2, the performance profiling acquisition tool 120 is realized by an application layer. Therefore, at the time of acquiring the event information for a specific process registered by the user, to utilize various hardware resources of the processor 100 through the performance profiling acquisition tool 120, processing is performed according to general hardware resources access layers, such as accessing each hardware resource from an event acquisition library by way of a driver under the environment of the OS 110.

FIG. 3 is a block diagram of a configuration of the processor. Only functional units of the processor 100 utilized by the performance profiling acquisition tool 120 are depicted in FIG. 3. Therefore, although the processor 100 includes functional units identical to those of the conventional processor, such as the program executing unit 101 (see FIG. 1) including a clock core, illustration and description thereof are omitted.

As depicted in FIG. 3, the processor 100 includes an event mode setting register 301 that stores therein setting of a target event mode of the target program 111 being executed, a threshold register 302 that stores therein the threshold as a criterion of interrupt processing, and a comparator 303 in addition to the event context register 102, the context register 103, the comparator 104, and the event counter 105.

The event counter 105 receives information concerning an event being executed from the program executing unit 101 (see FIG. 1). The event counter 105 counts the event by causing an adder to add 1 if (as judged by the comparator inside the event counter 105) the event mode set in the event mode setting register 301 and the event being executed coincide and if a signal indicative of coincidence between the process ID registered in the event context register 102 and the process ID recorded in the context register 103 is input from the comparator 104. Count results of the adder are stored in a memory area and are output in response to a call from the performance profiling acquisition tool 120.

Although the comparator 104 depicted in FIG. 1 receives input from the event context register 102 and the context register 103, alternatively, an arbitrary register may be added as a comparison condition. For example, if a register is added for distinguishing a running condition with kernel authorization/user authorization, according to the kernel authorization/user authorization, a specific event of a specific process can be targeted.

The comparator 303 in the processor 100 can compare count results of the event counter with the threshold stored in the threshold register 302, and accordingly, execute a performance profile interrupt handler. Therefore, for each interrupt interval generated by the interrupt unit based on comparison results of the comparator 303, the event count, as counted by the event counter 105, for the target process indicated by the process ID can also be acquired as event information.

The reference of description returns to FIG. 2. For example, in a Linux system, a dedicated access driver is incorporated in the OS to acquire the event information of the process ID registered as a target. The driver has a function of setting the process ID in the event context register 102 to specify the target process.

The event acquisition library 200 stores therein the process ID of the target program and various parameters (event to be acquired, acquisition start instruction, acquisition end instruction, acquisition authorization, and threshold) specified by the user for an event acquiring function. By specifying the target from among the information stored by the performance profiling acquisition tool 120, an event acquiring driver 112 can be called.

Designation may be arbitrary for the event acquiring function stored in the event acquisition library 200. For example, example 1 is an example of using one function name and switching between the acquisition start and the acquisition end. Here, the function name will be “pa_driver(pid,para,mode,1);para(1:start,2:end),mode(event type),1(u:user,s:system)”.

Example 2 is an example of using separate functions of an acquisition start function:pa_start and an acquisition end function:pa_stop. Here, the function name will be “pa_start(pid,mode,1);”, “pa_stop(pid,mode,1);”.

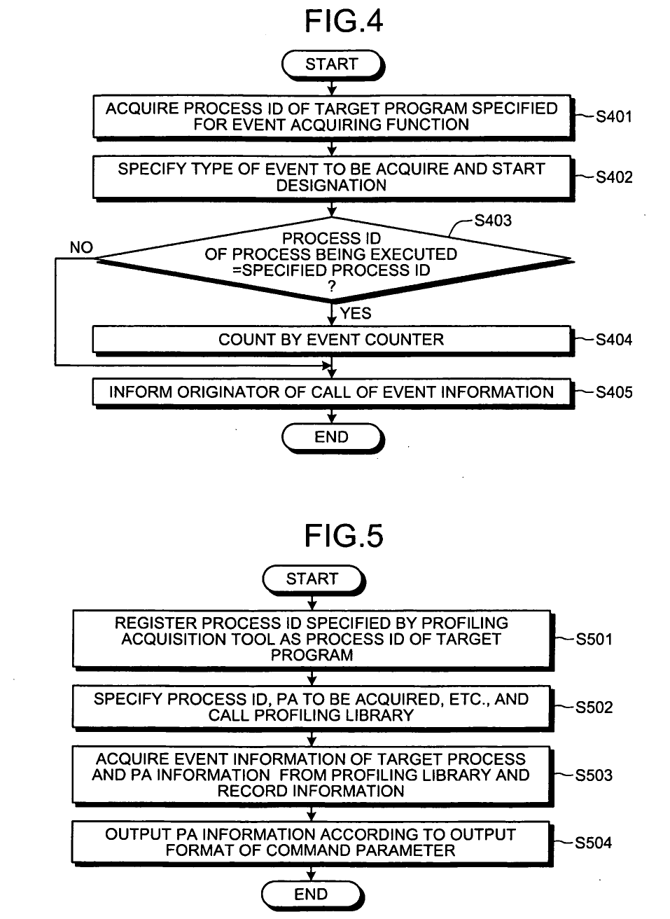

FIG. 4 depicts a flowchart of processing performed by the event acquiring driver. As depicted in FIG. 4, the process ID of the target program 111 specified by the user for the event acquiring function is acquired (step S401).

The type of event to be acquired and start designation are specified with respect to the event counter 105 (step S402). Whether the process ID of the process currently being executed in the processor 100 is equivalent to the process ID specified at step S401 is determined (step S403). If it is determined that the process ID of the process currently being executed is equivalent to the process ID specified at step S401 (step S403: YES), the event counter 105 counts (step S404), and the event acquisition library 200, originator of the call, is informed of the event information (step S405), ending a sequence of processing. On the contrary, at step S403, if it is determined that the process ID of the process currently being executed is not equivalent to the process ID specified at step S401 (step S403: NO), processing proceeds directly to step S405, without execution of the processing at step S404.

While an exemplary outline of processing by the event acquiring driver and the event acquisition library has been described with respect to Linux, such processing is not dependent upon the kind or type of the OS and likewise is applicable to an environment without OS. In the present embodiment, the following description is made using Linux for the sake of convenience.

FIG. 5 is a flowchart of processing performed by the performance profiling acquisition tool. As depicted in FIG. 5, the ID of the process specified by the performance profiling acquisition tool 120 is registered as the process ID of the target to be measured (e.g., counted) (step S501).

The registered process ID, a PA to acquire, etc., are specified, and a profiling library is called (step S502) and the event information of the target process and PA information including various information such as that of the program counter is acquired from the called profiling library and is recorded (step S503).

The PA information (e.g., number of execution cycles, number of cache errors, etc.) is output according to the output format of command parameters (step S504), ending a sequence of processing. With respect to the output format at step S504, output is given according to program, function, processing, etc., for example.

The following are command examples in the performance profiling acquisition tool 120.

### Command Example 1

attachPA-set 1000-1 us-start-pa 3
Command to start acquisition of the PA information (PA type:3) for data cache having the process ID:1000 under the user authorization and the system authorization (−1 us)

attachPA-set 1000-stop
Command to terminate acquisition of the PA information for an instruction cache having the process ID:1000 and to display results

### Command Example 2

attachPA-start user_prog-pa 3
Command to start acquisition of the PA information (PA type:3) concurrently with the start of a program user_prog

attachPA-stop user_prog
Command to terminate acquisition of the program user_prog and display results

By executing the above commands, the following data is output.

### Output Display Example 1 (Batch Output)

data cache error information

data cache error ratio (a/b*100): 8.76%

data cache error cycles (a):19547

execution cycles (b):523141

The output display example above displays results acquired over the entire acquisition range by batch output. By combining this output display example 1 with the information acquired from the program counter, the location of event occurrence may be identified corresponding to the number of times an event occurs. Therefore, in the following output display example 2 (per function) and output example 3 (per instruction), in addition to a batch display of the event information (“number of execution cycles”, “cache error”, etc.), the event information may be output for each function and for each instruction. Output according to function and according to instruction enables the function or processing unit at the time of generation, of the event information to be identified, by checking the program counter information at the time of occurrence of the event. Symbol information, debug information, etc., are used for obtaining correspondence to the event information.

### Output Display Example 2 (Per Function)

data cache error information

event occurrence function:cache error cycle count

func1:12345 (7.11%)

func2:9345 (5.38%)

func3:8845 (5.09%)

. . . : . . . ( . . . )

total:173741

### Output Display Example 3 (Per Instruction)

data cache error information

event occurring address:cache error cycle count

0x0020000:5582 (3.21%)

0x00100100:4126 (2.37%)

0x00201000:3991 (2.30%)

total:173741

A scheduler of the OS 110 performs processing to prevent the process ID from changing from the moment at which the performance profiling acquisition tool 120 is started. Specifically, when called by the driver in the OS 110, the context (process) of the target program 111 is set so as to prevent the process ID from being changed until execution of the target program 111 is finished, even in the case of becoming a subject of system swap. Such setting enables a situation to be prevented in which the process ID of the process being executed that is recorded in the context register 103 is changed by the system swap, etc., and determination of coincidence with the process ID of the target process that is registered in the event context register 102 made incorrectly.

The performance profiling acquisition tool 120 acquires event information specific to the selected process by adding hardware to the conventional processor. However, the performance profiling acquisition tool 120 according to the present embodiment may have the hardware function above realized by software. An example will be described of realizing the performance profiling acquisition tool 120 by software.

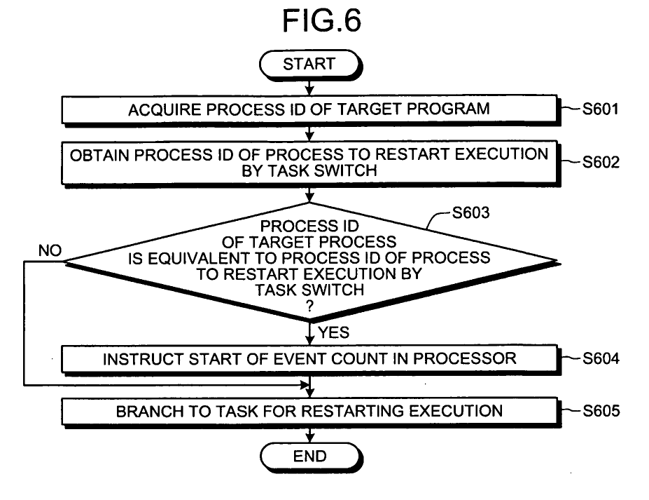

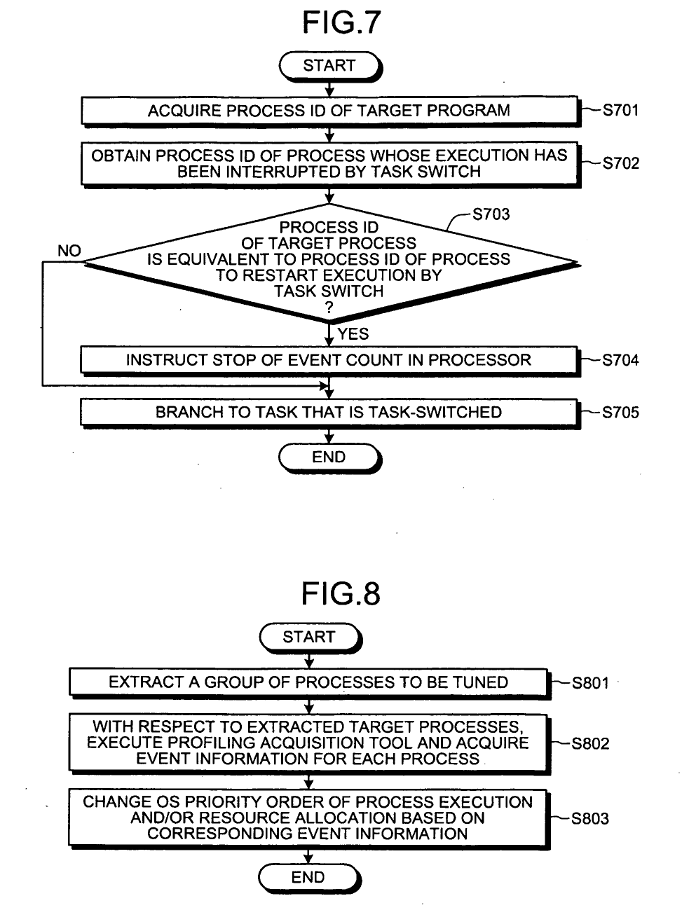

When neither the event context register nor the context register is incorporated in the processor 100, event counting may be performed by distinguishing the target process by software at the time of task switch of the kernel. A procedure will now be described of the kernel at the time of processing event information. FIGS. 6 and 7 are flowcharts of a procedure of the kernel at the time of acquisition of the event information. The flowchart of FIG. 6 depicts processing concerning the kernel that selects the process to start to execute. The flowchart of FIG. 7 depicts processing when the process is interrupted during execution and the control returns to the kernel.

As depicted in FIG. 6, the process ID of the target program is acquired (step S601). The process ID of the process to restart execution by the task switch is obtained (step S602). Whether the process ID of the target process and the process ID of the process to restart execution by the task switch are equivalent is determined (step S603).

At step S603, if it is determined that the process ID of the target process and the process ID of the process to restart execution by the task switch are equivalent (step S603: YES), start of event count in the processor 100 is instructed (step S604). A task of restarting execution is branched to (step S605, ending a sequence of processing. At step S603, if it is determined that the process ID of the target process and the process ID of the process to restart execution by the task switch are not equivalent (step S603: NO), processing proceeds directly to step S605, without execution of the processing at step S604.

As depicted in FIG. 7, the process ID of the target program 111 is acquired (step S701). The process ID of the process whose execution has been interrupted by the task switch is obtained (step S702). Whether the process ID of the target process and the process ID of the process whose execution has been interrupted by the task switch are equivalent is determined (step S703).

At step S703, if it is determined that the process ID of the target process and the process ID of the process whose execution has been interrupted by the task switch are equivalent (step S703: YES), stop of event count in the processor 100 is instructed (step S704). A task that is task-switched is branched to (step S705), ending a sequence of processing. At step S703, if it is determined that the process ID of the target process and the process ID of the process whose execution has been interrupted by the task switch are not equivalent (step S703: NO), then move directly to the processing of step S705, processing proceeds to step S704.

At step S603 and step S703, other arbitrary comparison conditions may be added. For example, by adding processing to distinguish a running condition with kernel authorization/user authorization, count may be made of a specific event of a specific process according to the kernel authorization/user authorization.

Thus, even if the dedicated processor 100 above is not installed, the performance profiling according to the present embodiment further enables realization of processing equivalent to the performance profiling acquisition tool 120 by a general-use computer, by adding a performance profiling program to implement the kernel processing above.

The present embodiment enables monitoring of the program condition, judging the execution condition of the process and the program, and performing tuning such as assigning program priority orders and allocating system resources, based on the event information acquired by the performance profiling acquisition tool 120.

In particular, the performance profiling acquisition tool 120 according to the present embodiment is capable of acquiring various performance profiling information without stopping the target program in an actual operating environment and therefore, is capable of reducing tuning procedures. The performance profiling acquisition tool 120 according to the present embodiment is capable of making the tuning related work efficient by, for example, allowing the tuning work to be started after extraction, from among programs under execution, of a program having low bus efficiency or a program with many stalls.

Such tuning may be performed as automatic monitoring of the program condition, judgment of the execution condition of the process and-the program, and assignment of the program priority order and allocation of the system resources, based on various event counts acquired. FIG. 8 is a flowchart of a tuning procedure based on the event information. The flowchart of FIG. 8 depicts the flow of monitoring the condition of the target program and automatically assigning the program priority order and allocating the system resources.

A group of processes to be tuned is extracted (step S801). The profiling acquiring tool is executed with respect to the processes to be tuned that are extracted at step S801 and the event information of each process is acquired (step S802). The OS priority order of process execution and/or allocation of the resources is changed based on corresponding event information to the process (step S803), ending a sequence of processing.

At step S801, the processes to be subject to tuning may be extracted based on an index that enables judgment of the process condition with respect to the OS (e.g., CPU running time, memory usage rate, I/O running time, network load rate, etc.), an arbitrary index defined externally, etc. Further, configuration may be such that specification of the process ID is received from the user and the process corresponding to the specified process ID is extracted.

When the above tuning in the OS is incorporated, configuration may be such that scheduling or allocation of resources are run at an arbitrary timing and results are fed back to the scheduling or the allocation of resources, or a control program for the OS may be prepared as an external tool.

When five processes greatest in the CPU running rate in the target program are selected by the processing at step S802 and the event information of each process is acquired, judgment is made, for example, as follows:
Lower, by one level, the priority order of the process with long I/O access wait.
Investigate a combination of processes having numerous cache errors and change scheduling so that processes having numerous cache errors will not run concurrently.
Lower operating frequency at the time of execution of a process having frequent idle states.
Adjust resource allocation, power reduction, etc. for a system called from a program having numerous cache errors or a shared library function.

The tuning above enables improved throughput and power reduction over the system as a whole. Described is only one example and criteria and details are not limited to those described herein and may be arbitrarily defined by the program or the user. The data can be merged to create a database storing an empirical value and the value may automatically be utilized. By storing a merged value as an empirical value in a memory each time the information is acquired, accuracy of the profiling can be improved.

For more efficient use of the performance profiling acquisition tool 120, input-output graphical user interfaces (GUIs) that are user-friendly are prepared.

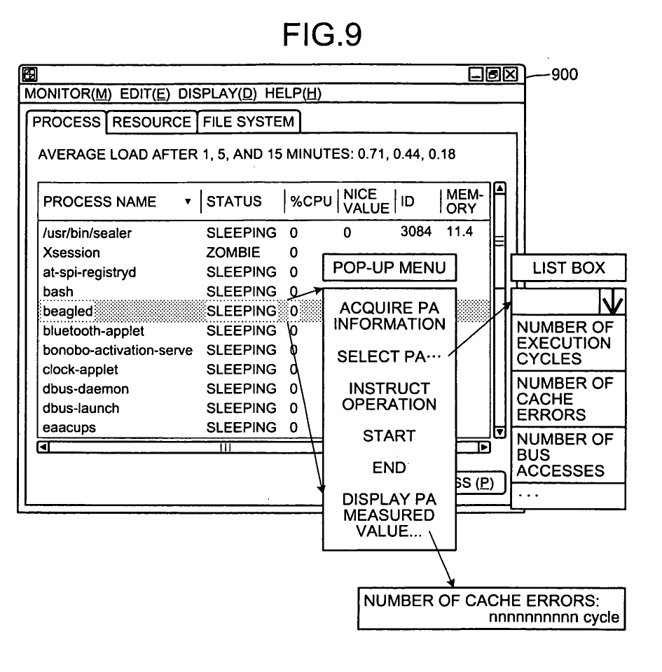

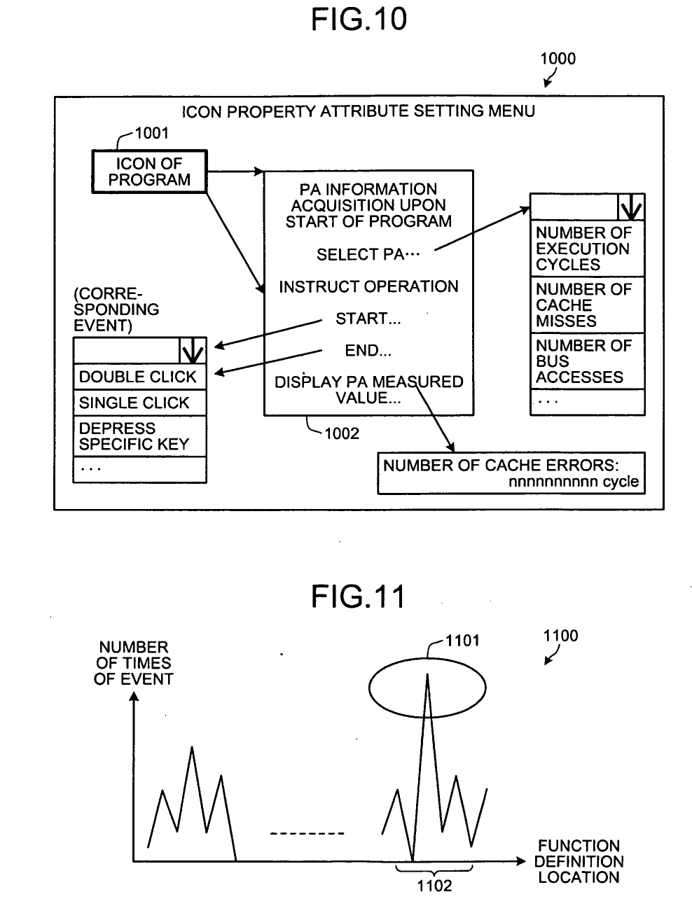

FIGS. 9 and 10 are schematics of an input example of the performance profiling acquisition tool. As depicted in FIG. 9, a window 900 is prepared that enables selection, with the aid of a management tool of the OS, of a PA to be measured, in the command example 1. The window 900 is displayed when the performance profiling acquisition tool 120 is selected from the management tool of the OS 110 by a started process. A pop-up menu is displayed when the cursor is placed on a process name in the window 900.

The pop-up menu displays various items for acquiring the PA information. Specifically, items such as a menu for specifying operations of measurement start and end, and a menu for displaying acquired PA information are prepared as the pot-up menu. When the cursor is placed on these items, a list box, etc., for further selection of the PA items is displayed, thereby enabling operation by a method superior to that of a command interface. When the profiling acquiring tool has other parameters, other menus may arbitrarily be added. Graphical elements used for the GUI may be general-use graphical elements prepared for a window system independent of system type or original graphical elements (arbitrary).

As depicted in FIG. 10, a window 1000 is prepared that enables selection, with the aid of the management tool of the OS, of the PA to be measured, in the command example 2. In the window 1000 of the GUI display, when the PA event information is to be acquired upon the start of the target program 111, setting is made so that the target program 111 will be started, triggered by the selection of an icon for the target program or the selection of the performance profiling acquisition tool 120 from a start menu (the attachPA-start command in the command example 2). The window 1000 depicted in FIG. 10 depicts a case in which an icon 1001 for the target program is selected (clicked, etc.) and the target program 111 is started.

A property attribute setting menu 1002 of the icon 1001 for the target program 111 is arranged so that the command of the command format 2 may be started internally. Setting is such that, from and linked to the property attribute setting menu 1002 of the icon 1001 for the target program 111, a selection menu of a PA type to be specified and a menu indicating PA measurement results are displayed. When the performance profiling acquisition tool 120 has other parameters, depending on contents of other parameters, corresponding menus may arbitrarily be added.

With respect to operation specification in the window 1000 by the user, setting is made so that, for example, by a double click, the target program will be started from the attachPA-start command of the command format 2. Further, setting is made so that, by a single click, the attachPA-stop command of the command format 2 will be started and the PA measurement will be stopped. Configuration may be such that correspondence to the double click and the single click is specified so as to comply with the correspondence in the window system and that the operation specification is correlated to the other arbitrary GUI operation event(s) above. An arbitrary extracting condition may be added in the pop-up menu. For example, a measurement condition may be set according to running condition with the kernel authorization/user authorization.

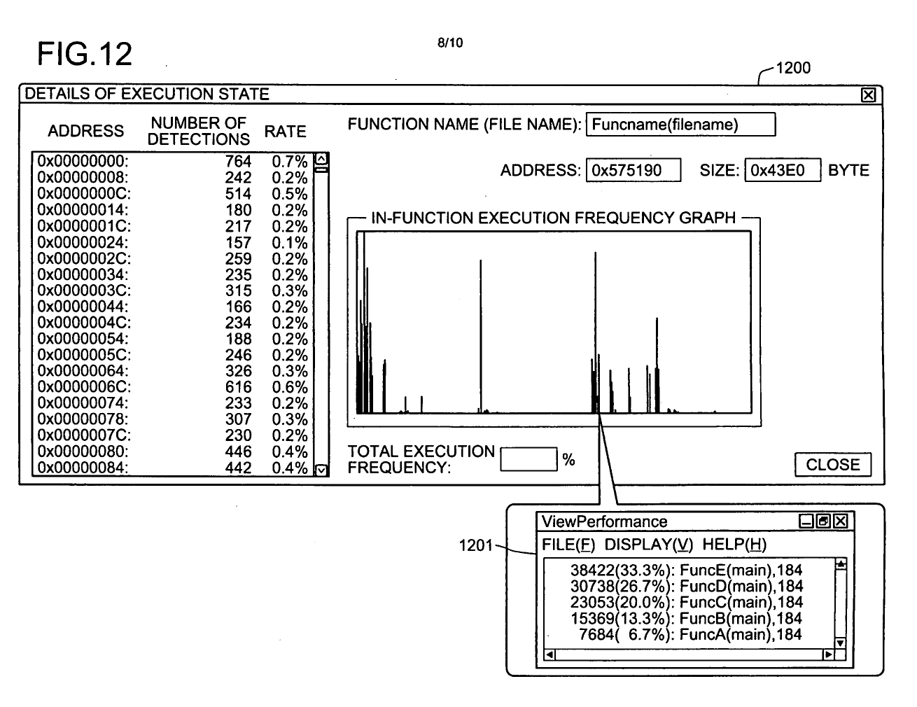

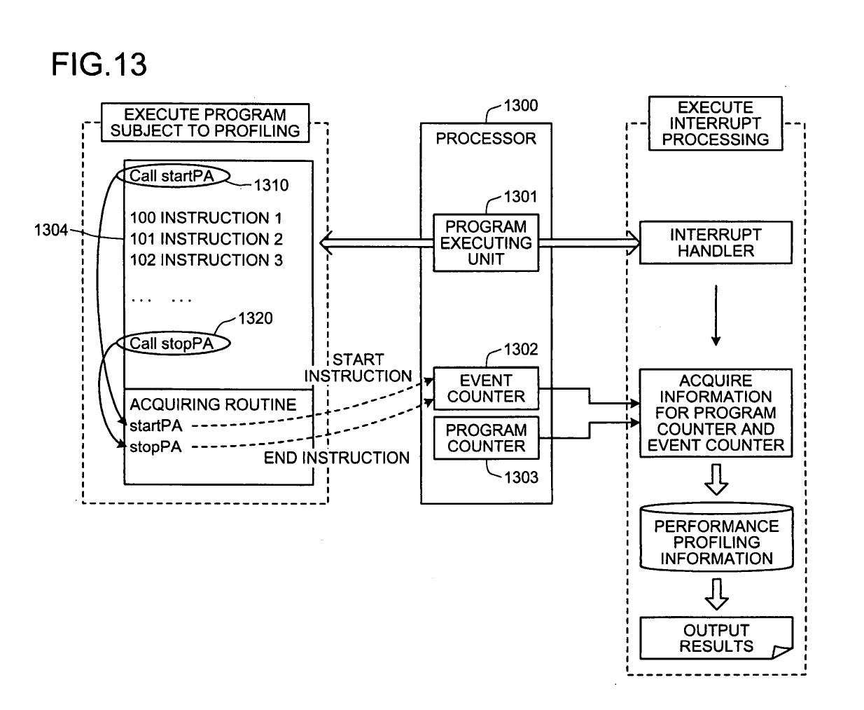

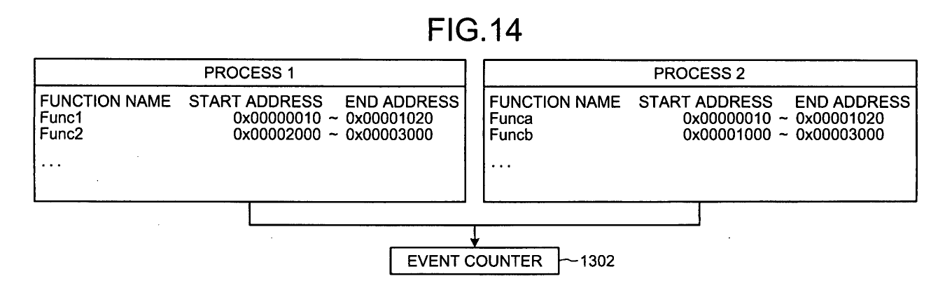

FIGS. 11 and 12 are schematics of an output example of the performance profiling acquisition tool. A graph 1100 depicted in FIG. 11 depicts count results of the number of events correlated with the function definition location by source name, function, and instruction address converted from the interrupt address. In the example depicted in the graph 1100, the count number (i.e., the event information) is great (relative to the output results) in the vicinity of the address of a portion 1101. Therefore, from the function definition location 1102 corresponding to the portion 1101, the process can be identified such as “source name S, function F, and address XXXXX”.

On the other hand, FIG. 12 depicts a window 1200 depicting count results of the number of events according to instruction within a function (see the graph 1100 of FIG. 11). Specifically, the window 1200 may be realized by adding a comparing processing unit that compares the number of times the event occurs (count number) acquired in the performance profiling acquisition tool 120 and the program being executed, and an extracting processing unit that, using results of the comparison, extracts from the application program, the function, the processing, and the instruction corresponding to the event that has come to have the value equal to or greater than a predetermined number, among the values acquired by the acquiring unit. At the time of output, the function, the processing, and the instruction extracted by the extracting processing unit are output. The window 1200 may be linked in such manner that, by clicking the location of the function or the instruction, a window 1201 indicating a corresponding source program or assembler source is displayed. An arbitrary display condition may be added to the configuration depicted in FIG. 12. For example, the display condition may be set according to running condition with the kernel authorization/user authorization, and display may be made by such conditions.

Thus, the performance profiling acquisition tool 120 according to the present embodiment, by preparing the GUI for input as depicted in FIGS. 9 and 10, can provide a user-friendly operation environment. By displaying the event information graphically with the aid of the management tool of the operating system in the form of the GUI for output as depicted in FIGS. 11 and 12, operability is improved. As a result, higher efficiency of the tuning man-hour may be achieved.

As described above, application of the performance profiling according to the present embodiment enables acquisition of various types of tuning profiling information without stopping the target program in the actual operating environment. Therefore, tuning processing required of the user is reduced considerably. Higher efficiency of the tuning work may be achieved, such as allowing the tuning work to be started after extraction of a program of low bus efficiency or a program with many stalls, from among multiple programs under execution.

Since the application of the performance profiling according to the present embodiment enables acquisition of various types of tuning profiling information without stopping the target program in the actual operating environment, the tuning procedure may automatically be performed. For example, by automatically extracting from among multiple programs under execution, a program having low bus efficiency and/or a process part having many stalls and by the operating system performing optimal scheduling and optimization of execution performance and power consumption, execution efficiency and power efficiency of the entire system of these programs can be enhanced.

By applying the performance profiling according to the present embodiment, which does not add modifications to the source, etc. in the actual operating environment, the event information can be acquired without affecting overhead as occurs with modifications.

The application of the performance profiling according to the present embodiment not only enables acquisition of the event information with respect to a third-party-prepared program without availability of the source program, but further enhances the throughput of the system as a whole as compared to such acquisition conventionally performed. Therefore, an advantage is the capability of tuning throughout the entire system, such as the user lowering the priority order of the third-party program having a long I/O access wait or the operating system automatically judging such priority order. Another advantage is the capability of investigating a combination of processes that causes many cache errors and changing the scheduling so that the combination of processes that causes numerous cache errors are run concurrently as little as possible. A further advantage is the capability of tuning to achieve reduced power consumption, by lowering the operating frequency at the execution time of the process with frequent idle state.

As described above, the application of the performance profiling according to the present embodiment enables acquisition of information concerning the behavior of a specified program, without modifications to or stopping execution of the program being executed in the OS environment.

The present embodiment enables acquiring information concerning a specified event among events making up an application program.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A processor capable of executing an arbitrary application program on an operating system, comprising:
an event context register that stores therein an ID of an event to be measured in the arbitrary application program;
a context register that records therein an ID of an event executed by the arbitrary application program upon the application program being executed on the operating system;
a comparator that compares the ID of the event recorded in the context register and the ID of the event to be measured that is stored in the event context register; and
an event counter that counts the number of times the ID of the event recorded in the context register and the ID of the event to be measured are determined to coincide by the comparator.

2. The processor according to claim 1, wherein the event context register stores therein an ID indicative of any one of a process, a task, and a thread as the ID of the event to be measured, and
the context register, upon execution of the event of the arbitrary application program on the OS, records an ID of a type identical to a type of the ID registered in the event context register as the ID of the executed event.

3. A performance profiling apparatus comprising:
a processor that is capable of executing an arbitrary application program on an operating system and includes:
an event context register that stores therein an ID of an event to be measured in the arbitrary application program,
a context register that records therein an ID of an event executed by the arbitrary application program upon the application program being is executed on the operating system,
a comparator that compares the ID of the event recorded in the context register and the ID of the event to be measured that is stored in the event context register, and
an event counter that counts the number of times the ID of the event recorded in the context register and the ID of the event to be measured are determined to coincide by the comparator;
an acquiring unit that, upon execution of the arbitrary application program by the processor, acquires a value obtained by the event counter; and
an output unit that outputs information acquired by the acquiring unit.

4. The performance profiling apparatus according to claim 3, wherein
the processor further includes a program counter,
the acquiring unit acquires from the program counter in the processor, a program count value at the time of acquiring the value obtained by the event counter, and
the output unit outputs the value of the event counter and the program count value acquired by the acquiring unit.

5. The performance profiling apparatus according to claim 3, further comprising
an interrupt unit that generates an interrupt at given intervals upon the application program being executed, wherein
the acquiring unit acquires the value obtained by the event counter at each interrupt interval generated by the interrupt unit.

6. The performance profiling apparatus according to claim 3, further comprising:
a comparing unit that compares the value acquired by the acquiring unit and the application program; and
an extracting unit that, using comparison results obtained by the comparing unit, extracts from the application program, a function, processing, and an instruction corresponding to the event that has come to have a value equal to or greater than a predetermined number, among the values acquired by the acquiring unit, wherein
the output unit outputs the function, the processing, and the instruction extracted by the extracting unit.

7. The performance profiling apparatus according to claim 6, wherein
the output unit outputs the function, the processing, and the instruction extracted by the extracting unit together with a corresponding source program or machine language instruction.

8. The performance profiling apparatus according to claim 3, further comprising
a recording unit that merges into a predetermined memory, the information acquired by the acquiring unit.

9. The performance profiling apparatus according to claim 3, further comprising
a setting unit that sets a program priority order according to the information output by the output unit and execution state of the application program.

10. The performance profiling apparatus of claim 9, wherein
the setting unit includes a setting unit that sets allocation of system resources according to output by the output unit and execution state of the application program.

11. A computer-readable recording medium storing therein a program that causes a computer capable of executing an arbitrary application program on an operating system to execute:
storing an ID of an event to be measured in the arbitrary application program;
recording an ID of an event executed by the arbitrary application program upon the application program being executed on the operating system;
comparing the ID of the event recorded at the recording and the ID of the event to be measured that is stored at the storing;
counting, as event information, the number of times the ID of the event recorded at the recording and the ID of the event to be measured are determined to coincide at the comparing; and
outputting a value obtained at the counting.

12. The computer-readable recording medium according to claim 11 storing therein the program that further causes the computer to execute
acquiring from a program counter in the computer, a program count value at the time the value is obtained at the counting, wherein
the outputting includes outputting the program count value acquired at the acquiring and the value obtained at the counting.

13. A performance profiling method of a computer having a plurality of registers and a processor capable of executing an arbitrary application program on an operating system, the performance profiling method comprising:
recording, upon execution of the arbitrary application program on the operating system, an ID of an event executed by the application program in a first register among the registers;
comparing the ID recorded in the first register at the recording and an ID of an event to be measured that is registered in advance in a second register among the registers; and
counting, as the event information, the number of times the ID recorded in the first register at the recording and the ID of the event to be measured are determined to coincide at the comparing.
